(19) United States
(12) Patent Application Publication
(10) Pub. No.: US 2016/0281927 A1
(43) Pub. Date: Sep. 29, 2016

(54) LIQUID NATURAL GAS TRANSFER

(71) Applicant: KOSAN CRISPLANT A/S, Aarhus N (DK)

(72) Inventors: Anders Bjørn, Randers SØ (DK); Anders Würtz Nielsen, Aarhus N (DK); Anders Dahl Jørgensen, Langå (DK)

(73) Assignee: Kosan Crisplant A/S/, Aarhus (DK)

(21) Appl. No.: 15/035,723

(22) PCT Filed: Dec. 12, 2014
(86) PCT No.: PCT/DK2014/050427

§ 371 Date: May 10, 2016

(30) Foreign Application Priority Data
Dec. 19, 2013 (DK) PA 2013 70790

(51) Int. Cl. F17C 5/02; B63B 25/12; F17C 7/02

(52) U.S. Cl. CPC F17C 5/02; F17C 7/02; B63B 25/12; F17C 2205/0355; F17C 2205/0364; F17C 2205/037; F17C 2221/033; F17C 2227/0135; F17C 2265/065; F17C 2265/07; F17C 2270/0105

(57) ABSTRACT

In order to provide improved efficiency, e.g. in terms of how to operate and maintain a liquid natural gas (LNG) transfer system, while also improving the environmental friendliness of the transfer operation, there is disclosed a method and system of transferring liquid natural gas from a first container 104 to a second container 106 via a pump station 108. The first container 104 is positioned close to the pump station 108 by a truck 110, and the second container 106 is positioned close to the pump station 108 by a ship 112. Repeated transfer of LNG is provided using first and second dry couplings 304, 308 and, after transfer is complete, disconnecting the second dry coupling 308 from the second container and providing a flow of liquid natural gas back into the first container utilising an overpressure in the insulated pipes or hoses 202, 208 and in pipes of the pump station relatively to the pressure in the first container and by replacing the first container 104 with a filled first container when the first container is empty.

### FIELD OF THE INVENTION

The invention relates to transfer of natural gas, which has been liquefied to become liquid natural gas (LNG) or liquefied natural gas (LNG), from a first to a second container. The invention is in an embodiment explained in connection with transfer of LNG to a second container positioned in a LNG powered vessel, ship or ferry, such as for a ferry route.

### BACKGROUND OF THE INVENTION

Natural gas boils at a temperature of about minus 160° C.−minus 164° C. when under a pressure close to normal atmospheric pressure (about 101.3 kPa at sea level), mainly depending on the amount of methane in the gas, of which natural gas typically contains 80-95%.

In order to provide an efficient, also in terms of cost, storage or transport of natural gas, the gas is liquefied into liquid state, LNG. LNG typically takes up about 0.15-0.2% of the volume of natural gas in gaseous state. LNG is typically transported in cryogenic, insulated containers by road or sea.

As also explained in EP2212186, marine vessels can be fuelled by LNG. Also with LNG, marine vessels need to be refuelled, also called bunkered, at certain intervals. Bunkering operation usually takes place in port, but may also take place at other locations, such as at a floating bunkering facility out at sea.

Bunkering operation of a LNG fuelled marine vessel may take a long time. A reason for this is the temperature difference between LNG (normally stored at about −162° C.) and the bunkering line (normally in ambient temperature, around −10° C. to +25° C. for northern Europe). This temperature difference causes at least a part of the LNG to boil in the bunkering line, which leads to a two-phase flow of gas and liquid. The two-phase flow may cause control problems and pressure pulses, which may be harmful for the supply procedure and for the piping arrangements of the bunkering system.

Consequently, in order to arrive at a functioning bunkering operation, LNG flow rate may have to be kept low in the beginning of the operation in order to minimize, or at least in an attempt to keep the pressure pulses at an acceptable level. After the bunkering line starts to cool down, the flow rate may slowly be increased. A typical practice and trend in marine vessel operation of today is shortened port times and increased operating speeds, which leads to a transfer of larger amounts of fuel in a shorter time.

These and other factors influence a short and/or long term efficiency, e.g. in terms of how to operate and maintain the transfer system, but also influences an environmental friendliness of the transfer (or bunkering) operation. Hence, the inventors of the present invention have appreciated that an improved method and system for transfer of liquid natural gas is of benefit, and have in consequence devised the present invention.

### SUMMARY OF THE INVENTION

It may be seen as an object of the present invention to provide an improved method and system for transfer of liquid natural gas from a first to a second container. Preferably, the invention alleviates, mitigates or eliminates one or more of the above or other disadvantages singly or in any combination.

In particular, it may be seen as an object of the invention to provide a method of transferring liquid natural gas from a first container to a second container, which method provides improved short and long term efficiency, in terms of how to operate and maintain the system, while also improving the environmental friendliness of the transfer operation, when compared to known methods and systems.

Accordingly, in a first aspect, there is provided, a method of transferring liquid natural gas from a first container to a second container via a pump station, the method comprising
a) positioning the first container close to, such as less than 25 meter from, the pump station by a motor driven vehicle, such as a truck,
b) positioning the second container close to, such as less than 25 meter from, the pump station by a mobile unit, such as a truck or a ship,
c) transferring the liquid natural gas from the first container to the pump station via a first thermally insulated pipe or hose connected at a first end with a first dry coupling to the first container, or to a first connection leading to the first container, and connected at a second end to the pump station,
d) transferring the liquid natural gas from the pump station and into the second container by a pump in the pump station and via a second thermally insulated pipe or hose connected at a first end to the pump station and connected at a second end with a second dry coupling to the second container, or to a second connection leading to the second container, and, after transfer is complete,
e) disconnecting the second dry coupling at the second container or disconnecting it from the second connection leading to the second container and providing a flow of liquid natural gas back into the first container including utilising an overpressure in the insulated pipes or hoses and in pipes of the pump station relatively to the pressure in the first container to provide said flow, and
f) filling the second container a plurality of times with liquid natural gas from the first container and/or filling a plurality of different second containers with liquid natural gas from the first container by repeating method steps b)-e),
g) replacing the first container with a filled first container by performing method step a) when the first container is empty.

Thus, an improved method of transferring liquid natural gas from a first to a second container is provided.

The present method utilises a pump for transfer of the liquid natural gas (LNG) to the second container. The pump is positioned apart from the first and second containers in a pump station. Further, the first container containing bulk LNG for transfer of the LNG to the second container is of a kind which, when filled with LNG, can easily be positioned at the pump station as described herein and by a motor driven vehicle.

In short, these features (of method steps a) and b)) distinguishes the present invention over at least some of the prior art and provides for a method and system which does not, as examples, require a crane for moving a filled container, as likely needed in WO2011124748, or a (large, non-moveable) fixed container at the bunkering site to be filled and refilled for later transfer of LNG to a further container and does also not require an extensive filling time to pass for transferring a certain amount of gas, among others due to the use of a pump station.

Further, it is found that the method distinguishes over the prior art when also including method steps c) and d) as described. Here, a dry coupling is to include a coupling including a male part and a female part, which male and female parts are each closed when they are not connected to each other, and where flow through the coupling is only possible when they are connected together. Further, and for the present purpose, effectively no volume at all is present between male and female parts when or if connected. The male and female parts are typically provided as one part on each of the two connections to be connected.

The conjunction of those method steps with method step e) along with repeated filling of second containers in f) and replacing of the first container in step g) may be seen to provide improved short and long term efficiency of the method and system, in terms of how to operate and maintain the system, while also improving the environmental friendliness of the transfer operation.

Particularly, and with the method and system described herein, it is also prevented to purge the system with, e.g., nitrogen as described in EP2212186 section [0035], in order to clean various parts of the system between separate filling cycles, which nitrogen will then itself (as an insight by the present inventors) have to be cleaned out of the system with NG or LNG, which purging and following cleaning out the nitrogen process takes time and results in rather extensive use of nitrogen and typically also results in release of both nitrogen and NG to the atmosphere, at least in the process of cleaning out the nitrogen used to clean out the LNG.

If not cleaning out the nitrogen, it is an insight of the present inventors that such nitrogen at least partly hinders an efficient subsequent transfer process and/or a short term and/or long term effectiveness of the LNG powered motor, system or similar using the LNG transferred to the second container, but the present inventors have devised an effective method and system without using nitrogen for such purging purposes. Nitrogen may be used during certain maintenance procedures of the system, but is not needed between filling cycles.

When including the optional features of initiating the flow of liquid natural gas back into the first container after transfer of liquid natural gas to the second container has been stopped for a period of time, this provides for an ability to have fast filling cycles without a flow back into the first container, which may be particularly useful when the method and system is used for transfer of LNG to second containers for or in a LNG powered truck. For such purpose the containers may arrive or be conveyed to the pump station at a rate where immediate flow back of LNG into the first container can be considered inefficient. The period of time may be selected to be such as 30 seconds, 45 seconds, 60 seconds, 2, 3, 4 or 5 minutes, but unlikely longer except for when extensive insulation can be provided for piping in the pump station, hoses etc. and/or under extreme cold ambient conditions.

Even though the method describes a flow back of LNG to the first container, an amount (likely minor and among others dependent on the various pressures and temperatures, dimension and length of the hoses etc.) of LNG and/or mixture of LNG and NG may remain in the hoses and in pipes of the pump station. When utilising at least part or all of such remaining fluid of the natural gas in the insulated pipes or hoses and in the pump station, after transfer of the liquid natural gas from the first container to the second container, for cooling parts of the pump station or hoses for that matter, rather fast filling cycles can particularly be performed with improved efficiency. Such rather fast filling cycles may be filling a container every 30 seconds, every minute, every 5 minutes, every 10 minutes, every 15 minutes or every 30 or 60 minutes.

As an alternative to venting NG to the atmosphere, which is found unwanted, at least part of or all of any remaining fluid, if any is there, of the natural gas in the first and/or second insulated pipes or hoses and in the (pipes of the) pump station can be converted into another form of energy by a converting device. Hereby a source of energy, such as for at least partly powering the pump station, such as at least partly powering a control system of the pump station, is provided. The converting device may comprise a fuel cell converting the fluid into electricity.

By converting any remaining fluid, if any, into another form of energy, a method and system is provided which also enables prevention of release of NG into the atmosphere and which does also not need use of nitrogen as explained above.

At least in order to provide a safe vent to a safe height and e.g. to prevent pressures above a certain threshold in the pump station, at least part of remaining natural gas in the insulated pipes or hoses and in (the pipes of and/or in the pump of) the pump station may be vented to the atmosphere via one or more safety valves and to the safe height vent. The pressure threshold can be selected such as to be 800 kPa, 1000 kPa, 1200 or 1500 kPa.

In accordance with an embodiment at least the pump is precooled prior to filling the second container by recirculating liquid natural gas from the first container through the pump and back into the first container via a recirculation flow path. Hereby increased flow rates can be accomplished afterwards, especially for systems and pumps working at best with such precooling. In such method and system a recirculation flow path is provided between the pump station and the first container. Further, in at least one way of providing such recirculation path (see FIG. 4), the recirculation path may be used to recirculate LNG being forwarded by the pump in the pumping station, e.g. in case of unforeseen circumstances such as sudden closing of a safety valve in, or in connection with, the pump station or a safety valve closing in a device, such as a ship, where the second container is placed or to be placed. This may particularly and as an example be of use in a system where the pump is rather slow reacting to such unforeseen circumstances and thus e.g. to prevent improper pressure build up in the hoses or pump station.

In accordance with a second aspect of the invention there is provided a system for transfer of liquid natural gas and adapted to perform the method in accordance with the method as described.

According to a particular embodiment of such system, the pump station is provided as a separate unit, such as in a container, and the pump is included in this container. By incorporating the pump and various other equipment, such as valves etc. in the container, a separate pump station is provided as a mobile unit which is easy moveable.

According to preferred embodiments, the system and method as described herein is used for transferring liquid natural gas to a second container, the second container being intended for a liquid natural gas powered ship or the second container being provided in a liquid natural gas powered ship, such as a ferry, or for transferring liquid natural gas to a second container for or in an liquid natural gas powered vehicle. For such use, a cyclic refilling of the container in the LNG powered means of transportation occurs, which refilling is found in need of improvement, and thus the present invention has been devised.

By referring to an advantage herein, it must be understood that this advantage may be seen as a possible advantage provided by the invention, but it may also be understood that the invention is particularly, but not exclusively, advantageous for obtaining the described advantage.

In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 is a top view of a site where LNG is transferred from a first to a second container with a system for transfer of LNG,

FIG. 2 is a close up view of FIG. 1,

FIG. 3 is a simplified and explanatory piping and instrumentation diagram (P&ID) of the system for transfer of LNG,

FIG. 4 is a simplified and explanatory P&ID showing a recirculation path including an internal path,

FIG. 5 is a simplified and explanatory P&ID showing inlet side hoses parking positions, and

FIGS. 6-8 are perspective views of the system for transfer of LNG.

List of reference numbers with description (the first number refer to the FIG. number in which the reference was shown/described firstly):

104 First container

106 Second container

108 Pump station

110 Truck for delivering first container

112 LNG powered ship

202 First thermally insulated pipe or hose

204 First end of 202

206 Second end of 202

208 Second thermally insulated pipe or hose

210 First end of 208

212 Second end of 208

302 System for transfer of LNG

304 First dry coupling

305 First break away coupling

306 Pump

307 Recirculation pipe or hose

308 Second dry coupling

309 Second break away coupling

310 Second connection leading to second container

312 First connection leading to first container

314 Fuel cell

316 Control system for pump station

318 Safe height vent

320 N2 battery (for service)

322 Automatic valve

324 Manual valve

326 Strainer/filter

328 Safety valve

402 Recirculation path including internal path

502 Parking positions inlet side

504 Parking position for 2nd thermally insulated pipe or hose (outlet side)

### DESCRIPTION OF EMBODIMENTS

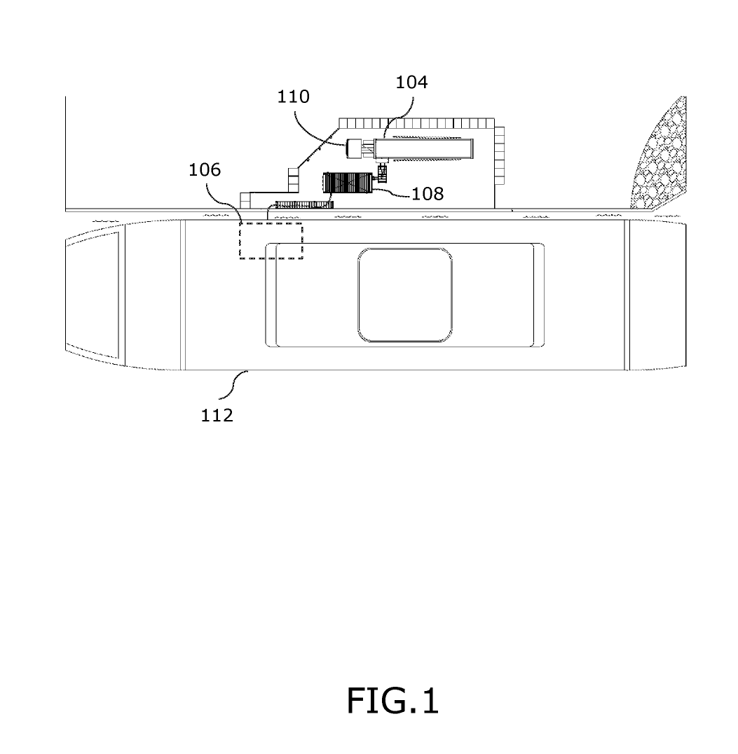

FIG. 1 is a top view of a site where LNG is transferred from a first container 104 to a second container 106 with a system for transfer of LNG. The first container is preferably a cryogenic LNG-ISO container. In the embodiment, the first container has arrived by truck and is positioned on a semitrailer, i.e. a trailer without a front axle, and is positioned in an enclosed area close to a pump station 108. In the shown embodiment the motored vehicle, embodied as a truck 110, which is positioned the first container next to the pump station is still on site. At least for some sites, the truck may leave the site and return again when the first container is empty and to replace the empty container with a filled one. In the shown embodiment, the second container 106 is included in a LNG powered ship 112, but could as well be a container in a truck or a container for a truck or for a ship.

The LNG-ISO container (first container) is preferably and as illustrated positioned within a fencing assuring that the container is safeguarded against impact by other vehicles or similar and that the container is positioned at a given position relatively to the pump station. Further, the LNG-ISO container is preferably positioned on a platform, which platform is vaguely angled for the LNG to flow towards a connection for transfer of liquid natural gas out of the container. Hereby also a flow of LNG at least partly by gravity can be provided.

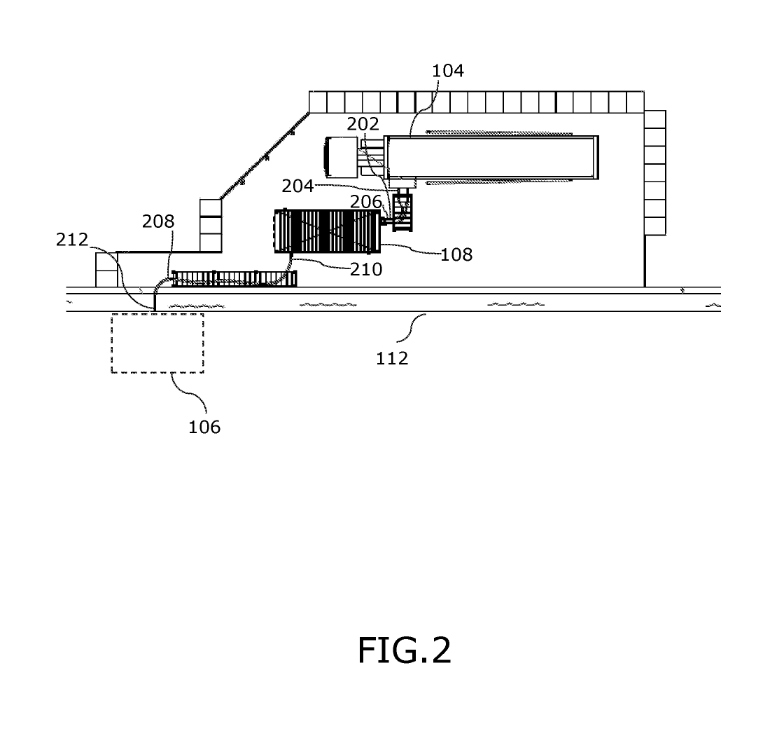

In the close up of FIG. 2, a first thermally insulated pipe or hose 202 is shown leading from the first container to the pump station 108. In the embodiment the first thermally insulated pipe or hose 202 is a flexible hose. The first thermally insulated pipe or hose 202 has a first end 204 operably connected to the first container 104 and a second end 206 operably connected to the pump station 108 at an inlet side of the pump station. It also follows that a second thermally insulated pipe or hose 208 with its first end 210 operably connected to the pump station and its second end 212 operably connected to the second container leads from the pump station 108 to the second container 106 on-board the ship 112.

Preferably and typically, both the first and second containers are themselves thermally insulated, among others to reduce an amount of energy being transferred from the ambient conditions to inside the containers. Such insulation, as efficient as it is, will not keep LNG cold enough by itself. Ambient heat will warm and vaporize the LNG, at least to some extent and depending on various factors such as time. It is practice to store LNG as a boiling cryogen. The LNG is stored at its boiling point for the pressure at which it is stored. Herein, and for the first container, the LNG is stored at approximately standard atmospheric pressure.

As the vapour boils off, heat for the phase change cools the remaining liquid. Because the insulation is very efficient, only a relatively small amount of boil off is necessary to maintain temperature in this so called auto-refrigeration process. At least the first container is preferably including such system for maintaining a certain temperature of the stored LNG.

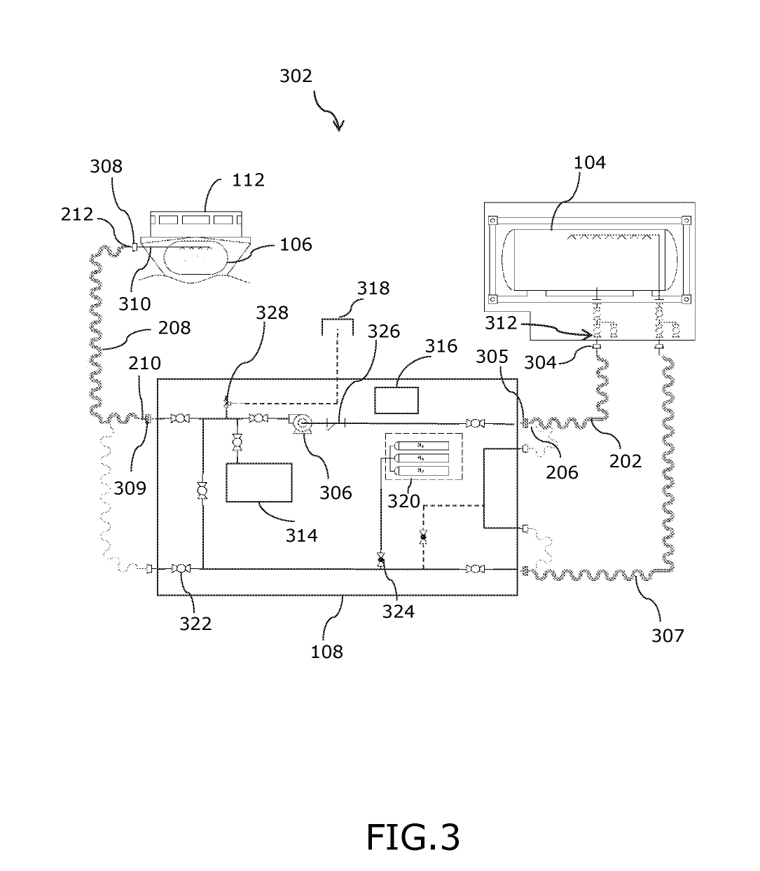

FIG. 3 is a simplified and explanatory piping and instrumentation diagram (P&ID) of the system for transfer of LNG according to an embodiment of the invention. The simplified P&ID illustrates a system adapted for transferring liquid natural gas from the first container 104 to the second container 106 via the pump station 108. The pump station is provided in a 20′ container, but may alternatively be provided in an 8′ or 10′ container or possibly in any other easily moveable container unit.

As seen the first container 104 is positioned next to the pump station 108 by the motor driven vehicle and the second container 106 is positioned next to the pump station 108 on the ship 112. Preferably, a minimum of distance is provided between the first container and the pump station and between the second container and the pump station, among others to reduce an amount of LNG in the thermally insulated hoses leading LNG from the first to the second container.

Transfer of liquid natural gas from the first container 104 to the pump station 108 is provided via the first thermally insulated pipe or hose 202 connected at the first end 204 with a first dry coupling 304 to the first container 104, or to a first connection 312 leading to the first container, and connected at the second end 206 to the pump station. The transfer also includes transferring the liquid natural gas from the pump station and into the second container 106 by a pump 306 in the pump station and via a second thermally insulated pipe or hose 208 connected at its first end 210 to the pump station and connected at its second end 212 with a second dry coupling 308 to the second container 106, or to a second connection 310, as illustrated, leading to the second container.

After transfer is complete, the second dry coupling 308 is disconnected at the second container or disconnected from the second connection 310, leading to the second container and there is provided a flow of liquid natural gas back into the first container. The flow of liquid natural gas back into the first container 104 is initiated after transfer of liquid natural gas to the second container and preferably after transfer has been stopped for a period of time.

The flow back into the first container 104 is provided utilising an overpressure in the insulated pipes or hoses 202, 208 and in pipes of the pump station. The pressure can be considered an overpressure relatively to the pressure in the first container. Hereby the second container 106 can be filled a plurality of times with liquid natural gas from the first container 104 by repeating the process described and replacing the first container 104 with a filled first container when the first container is empty. Instead of repeatedly filling the same container 106, a plurality of different second containers may be filled with the system and method as described herein.

A pressure difference between pipes etc. of the pumping station and the first container is preferably selected in the interval 50-700 kPa, more preferably between 200-600kPa, most preferred about 350-500 kPa. A difference of about 350-500 has e.g. been found to give the best trade-off between pipe dimensions, filling time (filling rate) and a time needed for the flow back into the first container. With a pressure difference of e.g. about 350-500 kPa, proper pipe dimensions, proper hose lengths etc., a time needed for the flow back of LNG is below 15 seconds, typically below 10 seconds, such as between 2-5 seconds.

The pump station includes a fuel cell 314 for converting at least part of any remaining fluid of the natural gas in the insulated pipes or hoses 202, 208 and in pipes of the pump station, after transfer of liquid natural gas from the first container to the second container into electricity. This energy can be used for at least partly powering the pump station 108 or parts of the pump station, such as a control system 316 of the pump station. The converting device can alternatively or additionally be used to convert at least part of any overpressure building up in the pump station and/or hoses due to any remaining LNG, if any is present, boiling off and becoming gas.

Among others as a safety measure the system comprises a safe height vent 318 which can be used for venting overpressure anywhere in the system. Only one safety valve 328 is shown, but it is to be understood that in order to include this function a plurality of safety valves and connection are to be provided. Here it is noted that LNG is not flammable or explosive in its liquid state. LNG vapours (its natural gas form) are only flammable within a limited range of concentration in the air. If the concentration of natural gas in the air is lower than 5% it cannot burn because of insufficient fuel. If the concentration of natural gas in the air is higher than 15% it cannot burn because there is insufficient oxygen. Therefore, the fire hazard of LNG is preconditioned on the LNG being released, the LNG vaporizing, mixing with air in a very narrow gas to air ratio of 5-15% and finally finding an ignition source. LNG vapor will only explode if in an enclosed space and if within the flammable range of 5%-15% when mixed with air, and if ignited.

In the pump station 108, e.g., the pressure and the flows are controlled by the control system 316, valves etc. and e.g. balanced and/or stabilized by venting NG via the safe valve(s) 328 and/or converting NG to another form of energy. During and just after pumping LNG from the first 104 to the second container 106, the pressure in the pipes of the pumping station 108 will preferably be around 500-900 kPa, more preferably around 700 kPa. This is also controlled in dependence of, among others, the pressure in the second container, which can be around 400 kPa when using these pressures in the pump station.

At least the pump 306 can be precooled prior to filling the second container 106 by recirculating liquid natural gas from the first container 104 through the pump 306 and back into the first container 104. This is provided via a recirculation flow path including a recirculation pipe or hose 307 leading from the pump station to the first container.

As illustrated, the system also includes break away couplings 305, 309 for preventing leakage in case of unforeseen moving of the first and/or the second container prior to disconnecting the dry couplings. The system further includes manual valves 324 as well as automatic valves 322 for controlling the flow. The N2 battery 320 is only for use when servicing the system.

According to possible embodiments of the invention, at least the second dry coupling 308 can be positioned at a level so that remaining LNG, if any remaining LNG is present in connections, pipes or hoses leading to the dry coupling is at least partly helped getting away from the dry coupling by gravity, and particularly prior to disconnecting the male and female parts of the dry coupling. Hereby, the dry coupling will easier be or remain dry, e.g. when disconnecting the coupling. As an example, the second dry coupling 308 can be positioned so that LNG in the pipe or hose 208 is helped by gravity to return to the pump station 108, and so that LNG in the second connection 310 is helped by gravity to flow away from the dry coupling and towards the second container 106.

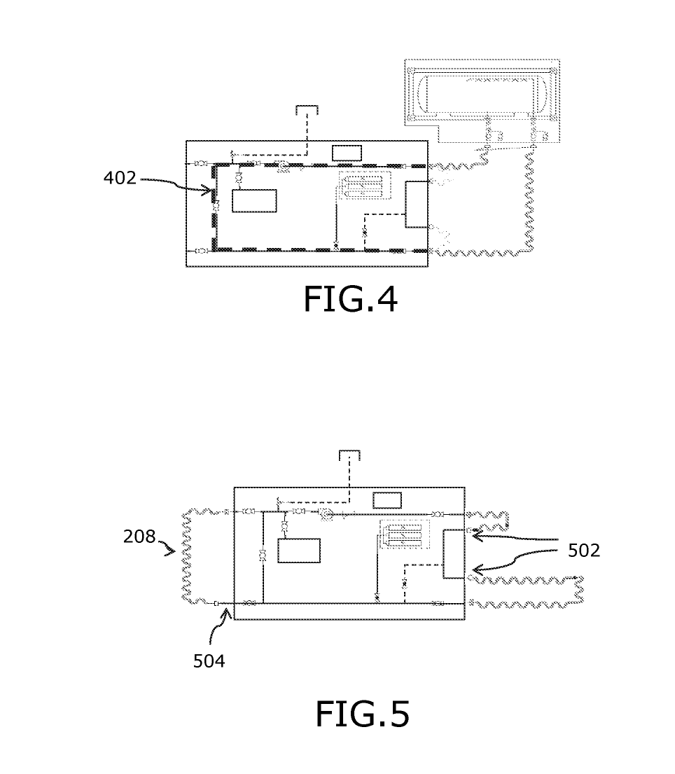

FIG. 4 is a simplified and explanatory P&ID showing a recirculation path including the path 402 in the pump station. Using this recirculation/cooling path enables precooling at least the pump 306 prior to filling the second container 106 by recirculating liquid natural gas from the first container 104 through the pump 306 and back into the first container.

FIG. 5 is a simplified and explanatory P&ID also showing inlet side hoses parking positions 502 in addition to the outlet side parking position 504. Such position of inlet and/or outlet hoses can e.g. be used when no first container is present and/or during service of the system. Alternatively and/or additionally such positions can be used when converting NG in the system into another form of energy.

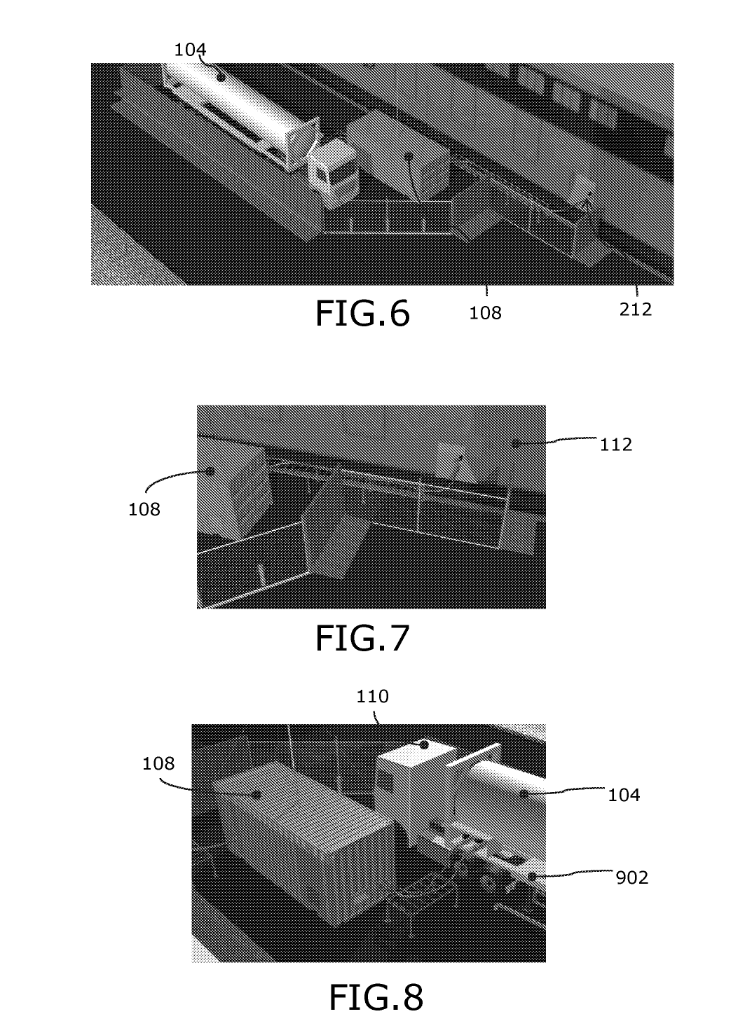

FIGS. 6-8 are perspective views of the system for transfer of LNG.

In short it is herein disclosed that in order to provide improved efficiency, e.g. in terms of how to operate and maintain a liquid natural gas (LNG) transfer system, while also improving the environmental friendliness of the transfer operation, there is disclosed a method and system of transferring liquid natural gas from a first container 104 to a second container 106 via a pump station 108. The first container 104 is positioned close to the pump station 108 by a truck 110, and the second container 106 is positioned close to the pump station 108 by a ship 112. Repeated transfer of LNG is provided using first and second dry couplings 304, 308 and, after transfer is complete, disconnecting the second dry coupling 308 from the second container and providing a flow of liquid natural gas back into the first container utilising an overpressure in the insulated pipes or hoses 202, 208 and in pipes of the pump station relatively to the pressure in the first container and by replacing the first container 104 with a filled first container when the first container is empty.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A method of transferring liquid natural gas from a first container to a second container via a pump station, the method comprising
a) positioning the first container less than 25 meter from, the pump station by a motor driven vehicle,
b) positioning the second container less than 25 meter from, the pump station by a mobile unit,
c) transferring the liquid natural gas from the first container to the pump station via a first thermally insulated pipe or hose connected at a first end with a first dry coupling to the first container, or to a first connection leading to the first container, and connected at a second end to the pump station,
d) transferring the liquid natural gas from the pump station and into the second container by a pump in the pump station and via a second thermally insulated pipe or hose connected at a first end to the pump station and connected at a second end with a second dry coupling to the second container, or to a second connection leading to the second container, and, after transfer is complete,
e) disconnecting the second dry coupling at the second container or disconnecting it from the second connection leading to the second container and providing a flow of liquid natural gas back into the first container including utilising an overpressure in the thermally insulated pipes or hoses and in pipes of the pump station relatively to a pressure in the first container to provide said flow, and
f) filling the second container a plurality of times with liquid natural gas from the first container and/or filling a plurality of different second containers with liquid natural gas from the first container by repeating method steps b)-e), and
g) replacing the first container with a filled first container by performing method step a) when the first container is empty.

2-13. (canceled)

14. The method according to claim 1, further comprising utilising at least part of any remaining fluid of natural gas in the thermally insulated pipes or hoses and in pipes of the pump station, after transfer of liquid natural gas from the first container to the second container, for cooling parts of the pump station.

15. The method according to claim 1, further comprising converting at least part of any remaining fluid of the natural gas in the thermally insulated pipes or hoses and in pipes of the pump station, after transfer of liquid natural gas from the first container to the second container, into another form of energy by a converting device.

16. The method according to claim 15, where said remaining fluid is converted into electricity by the converting device.

17. The method according to claim 16, where the converting device comprises a fuel cell.

18. The method according to 15, where the energy is used for at least partly powering the pump station.

19. The method according to claim 1, further comprising venting at least part of any remaining natural gas in the thermally insulated pipes or hoses and in pipes of the pump station to the atmosphere via a safe height vent.

20. The method according to claim 1, further comprising precooling at least the pump prior to filling the second container by recirculating liquid natural gas from the first container through the pump and back into the first container via a recirculation flow path.

21. A system for transfer of liquid natural gas via a pump station and adapted to perform the method according to claim 1.

22. The system according to claim 21, wherein the pump station is provided as a separate unit and where a pump is included in said separate unit.

23. The system according to claim 22, wherein the pump station is provided as a container, and where a pump is included in said container.

24. The method of claim 1, wherein the second container is configured for assembly with a liquid natural gas powered ship.

25. The method of claim 1, wherein, the second container is provided in a liquid natural gas powered ship.

26. The method of claim 25, wherein the ship is a liquid natural gas powered ferry.

27. The method of claim 1, wherein the second container is configured for assembly in a liquid natural gas powered vehicle.

28. The method of claim 27, wherein the vehicle is a liquid natural gas powered truck.
